(19) United States
(12) Patent Application Publication
(10) Pub. No.: US 2005/0103133 A1
(43) Pub. Date: May 19, 2005

(54) Device for the reading and the signalling of environmental parameters

(76) Inventors: Gianfranco Bizzotto, Bassano del Grappa (IT); Leonardo Buson, Vicenza (IT)

Correspondence Address: Dykema Gossett, Suite 300 West, 1300 I Street NW, Washington, DC, 20005-3306, US

(21) Appl. No.: 10/495,264

(22) PCT Filed: Nov. 20, 2002
(86) PCT No.: PCT/IT02/00738

(30) Foreign Application Priority Data
Nov. 22, 2001 (IT) V10A000244

(51) Int. Cl. G01D 7/00; G01H 3/12

(52) U.S. Cl. 73/866.1; 73/646; 73/866.3

(57) ABSTRACT

Device suitable for detecting, evaluating and indicating noise levels, in the form of acoustic pressure, present in a place of work or others, e.g. places of entertainment. The device is suitable for recording the levels themselves, for a long period of time, with the possibility of comparison with reference levels which have been defined either from regulations in force, or from interpersonal or business agreements. The result of the comparison is indicated with continuity at many points, particularly signifying the situation in the room, to define the state of normality, of alarm or of danger, with many optical indicators of the traffic light type, which with the lighting of the green, amber or red lights, signify the current level of acoustic pressure. At the same time, the electronic registration of the data is highlighted on a monitor, with a corresponding graph, to suggest the possible need for intervention to a control operator. The command foreseen for the optical indicator can otherwise be foreseen to command indicators of a different type which are considered more convenient in the particular room. Also, it is possible, with suitable feed back, to automatically limit or control the source of the disturbance.

The present invention has as its object a device for detecting, processing, indicating and recording, both electronically and on paper, sound.

It is known that exposure to certain levels of noise, for a certain amount of time, can cause temporary harm, like reduced reactivity, or permanent harm, like the loss of hearing, to the human body. Consequently, numerous countries have established health and safety laws and regulations, which prescribe the maximum levels and maximum time exposed, specifically, in places of work and places of leisure, respectively.

To this day the detection of noise levels reached in such places is carried out by specialised experts, employed by the relevant authorities, who carry out periodic measurements with suitable measurements apparatuses. Such experts, upon the basis of the detections carried out, dictate the interventions necessary to come into line with the regulations of the specific case.

A first intervention can consist of providing means suitable for indicating, in the aforementioned rooms, that an alarm or danger threshold has been reached, so that people can take suitable precautions.

A second type of intervention, mainly adopted in places of work, can consist of making people wear suitable protection like earmuffs, or else of sound-proofing, should this intervention be constructively possible and cost-effective.

On the market devices are already known which are suitable for controlling the acoustic pressure in a room, e.g. work sites, factories, discos, cinema, etc., and which are capable of giving an immediate reading when the sound pressure exceeds certain predetermined values, which can bother, or even damage, the people present in the room. Current devices comprise an electroacoustic transducer, which emits an electrical signal proportional to the acoustic pressure detected, to warn when the detected signal exceeds the threshold. The warning signal can activate acoustic indicator means like sirens.

The main drawback of current devices, as described above, is that the indication is not suited to certain environmental conditions in each specific room, e.g. work or entertainment room. Indeed, the use of an indication alarm, which emits a sound when a dangerous acoustic level is reached, causes a further worsening of the danger, in this situation.

The secondary drawback found in current devices consists of the fact that they do not foresee the possibility of collecting and recording the detections and the indications carried out apart from in a brief period and in a discontinuous manner. The new invention in object manages to collect documentation of the detected data, both for statistical evaluations and to guarantee the quality of the environmental conditions to also be presented as documentation for external inspection by authorities concerned with noise levels. All of the documentation regarding any previous readings, which is able to be stored indefinitely on an electronic memory, can be transferred onto a paper back-up.

The device proposed here as the new invention offers the possibility of evaluating, over long periods of time, the situation and the noise levels normally present at the room being checked, it offers the possibility of integrating the detected data, the main cause of physiological damage, also to justify a possible intervention on the noise source, or sound-proofing of the room.

In real time, the device which has been foreseen indicates to the user, in a particularly clear and immediate manner, the state of the noise levels, through three indicator lights, respectively signifying normal, alarm or danger status, suggesting or imposing appropriate interventions.

The scanning of the detected signal is processed by a program inserted in a personal computer, to realise a graph for each detector and to communicate, also over a distance, with a control operator, the possible need for intervention.

Further advantages of the invention shall become clearer from the description of a preferred embodiment thereof, illustrated for non-exclusive indicating purposes in the two attached tables of drawings, in which:

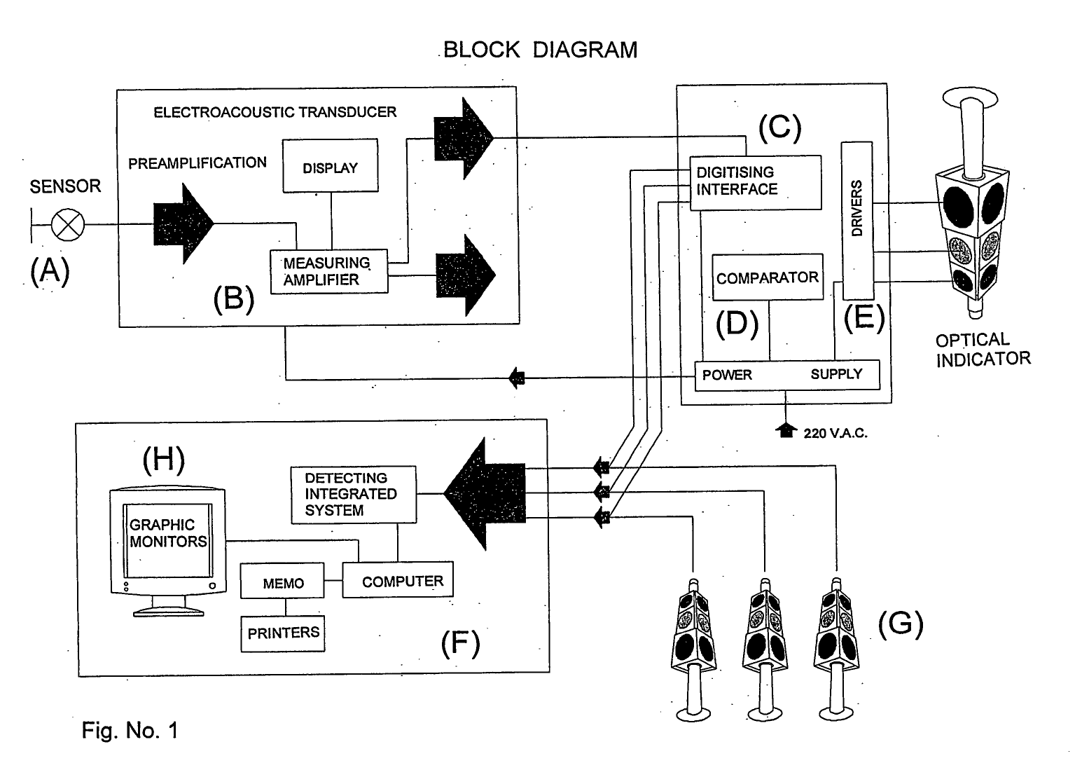

FIG. 1.—represents a block diagram of the device;

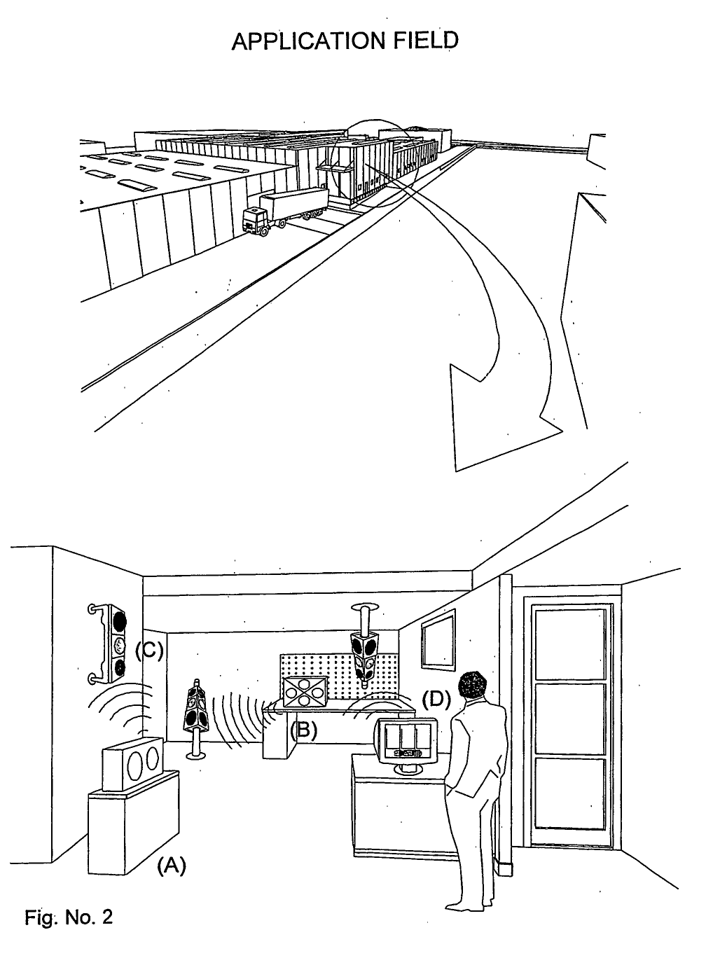

FIG. 2.—represents a perspective view of a practical example of application of said device.

With reference, in particular, to FIG. 1.-, the device comprises detector means (A) consisting of a plurality of microphonic transducer sensors, followed by amplifiers of the proportional voltage level representing the signal (B). The device also comprises digitisers of the signal which was originally analogue and a comparator (D) to compare the levels reached and thus read, with the calibration values.

The scanning, lasting a fraction of a second, of the results of the comparison, commands the drivers (E), to switch on the indicator lights of the colour corresponding to the value (G) reached and thus read within a traffic-light type structure, and transfers the signal to the electronic processing system for recording, to make a graph on the monitor (H) for each detection, for printing (F) the graphs processed and displayed on the monitor, and for the possibility of integrating the values reached for an effective global evaluation of the quality of the room.

With reference, in particular, to FIG. 2.- the image represents a testing room, representing a normal workplace or place of entertainment or other situation, consisting of a noise source (A) (alternative to a work tool or operating machine normally present at a work place): detection, processing and comparing systems (B) (C), structures, e.g. of the traffic-light type to highlight the results of the processing of the detections carried out; electronic systems for recording, storing and graphical representation on a monitor, with the possibility of hard copy documentation of the evaluations carried out (D).

In practice, it has been noted how the described device achieves the predetermined task and purposes.

Moreover, the Applicant wishes to underline how the instrumentation presented, using different detectors and transducers suitable for the detection, processing control and indication of the parameters other than noise, as currently foreseen, e.g. humidity, temperature, electromagnetic pollution, fine dusts, if necessary for the purpose, e.g. to continuously check the characteristics of a production process or of atmospheric conditions in a room. In the practical embodiment, the materials, the sizes and the embodiment details can be different from those presently indicated without, for this reason, departing from the scope of protection of the present invention.

1. Device for detecting and indicating at least one environment parameter, comprising transducer means suitable for detecting said at least one parameter detected at said environment and for producing at least one electrical signal in output proportional to it as well as indicator means, wherein said transducer means cooperate with digitising means of said at least one signal and at least one comparating unit suitable for comparing said at least one digital signal with at least one preset reference value to generate a command signal to said indicator means, said indicator means being of the optical type and representing the state of normality, alarm or danger of the level of said parameter detected at said environment.

2. Device according to claim 1, wherein said transducer means comprises at least one amplifier of the detected signal, arranged upstream of said digitising means, suitable for guaranteeing the reliability of the interpretation and transmission of said signal.

3. Device according to claim 1, wherein said indicator means, are of the traffic light type, usually associated with alarm and/or danger.

4. Device according to claim 3, wherein said traffic light type indicators comprise three lights in colours green, yellow and red, with which three noise levels inside said room are associated, representing normality, warning and danger respectively.

5. Device, according to claim 1, wherein it also comprises an electronic processing system for storing/recording, even for many years, the levels reached by said parameter detected by said transducer means.

6. Device according to claim 5, wherein said electronic processing system comprises means for filing said levels.

7. Device according to claim 6, wherein said filing means comprises at least one consultable memory unit suitable for containing said detected levels indefinitely.

8. Device according to claim 5, wherein said electronic processing system is equipped with at least one monitor suitable for graphically visualising directly or after suitable processing, said stored values, as well as their variations in a predetermined time period.

9. Device according to claim 5, wherein said processing system comprises at least one printing unit suitable for printing, directly or after suitable processing, said stored values as well as their variations in a predetermined time period.

10. Device according to claim 1, wherein said transducer means comprises at least one electroacoustic transducer suitable for detecting the acoustic pressure existing.

11. Device according to claim 1, wherein said transducer means comprises at least one transducer, suitable for detecting the humidity.

12. Device according to claim 1, wherein said transducer means comprises at least one transducer suitable for detecting the temperature.

13. Device according to claim 1, wherein said transducer means comprises at least one transducer suitable for detecting the electromagnetic pollution.

14. Device according to claim 1, wherein said transducer means comprises at least one transducer suitable for detecting the dusts.

15. Device, according to claim 1, wherein the amplifier and digitiser devices are fed by the mains.
